(19) United States
(12) Patent Application Publication
(10) Pub. No.: US 2019/0234202 A1
(43) Pub. Date: Aug. 1, 2019

(54) SYSTEM AND METHOD TRIANGULATION AND ZONE MANAGEMENT FOR DRILLING RIG COMMUNICATION COORDINATION

(71) Applicant: SCHLUMBERGER TECHNOLOGY CORPORATION, Sugar Land, TX (US)

(72) Inventors: Jacques ORBAN, Katy, TX (US); Vishwanathan PARMESHWAR, Houston, TX (US); Shunfeng ZHENG, Katy, TX (US)

(21) Appl. No.: 16/311,207

(22) PCT Filed: Jun. 22, 2017
(86) PCT No.: PCT/US2017/038628

§ 371 Date: Dec. 19, 2018

Related U.S. Application Data
(60) Provisional application No. 62/353,153, filed on Jun. 22, 2016.

(51) Int. Cl. E21B 47/12; G01S 5/02; E21B 44/00; G06F 17/15

(52) U.S. Cl. CPC E21B 47/122; G06F 17/15; E21B 44/00; G01S 5/0242

(57) ABSTRACT

A system for tracking a position on a rig site may include a plurality of static beacons of defined positions on the rig site configured to transmit reference signals at a selected triggering time for transmission; at least one moveable receiver at a first location on the rig site configured to receive the reference signals from the plurality of static beacons, determine the reception time of signal, and transmit reception information to a master node via a communication channel; wherein the master node is at a location on the rig site with a reference base time, wherein the master node receives the defined positions and reference times of the plurality of static beacons, and wherein the system is configured to, based on the reception information, determine signal travel times between the static beacons and the at least one moveable receiver, determine the distances between the static beacon and the at least one moveable receiver based on a travel time of the reference signals, and determine a position of the first location.

### CROSS-REFERENCE TO RELATED APPLICATIONS

This application claims priority to U.S. Patent Application No. 62/353,153, filed on Jun. 22, 2016, which is herein incorporated by reference in its entirety.

### BACKGROUND

A rig site may be made up of various equipment and workers. The major components of the rig site may be large (rig components during installation), such as the mud tanks, the mud pumps, the derrick or mast, the drawworks, the rotary table or top drive, the drill string, the power generation equipment and auxiliary equipment. Additionally, portable housing may be disposed on the rig site for a variety of uses. Furthermore, the rig site may have additionally components such as common tools and specialty tools for use by the rig or to be held continuously by the workers. Some of the aforementioned components may be moving regularly or for periods of time (and static in other periods) and some equipment is generally static for extends periods of time, if not the entirety of the time. Additionally, some of the equipment is on the rig floor. On some land drilling rigs, the rig floor of the rig is a relatively small work area in which the rig crew conducts operations, usually adding or removing tools in a wellbore. The rig floor is a quite dangerous location on the rig site because of all the moving components. However in offshore applications, the rig includes the same (or similar) components as onshore, but all the components are disposed on a vessel or drilling platform (most of the components are installed in a permanent fashion).

### SUMMARY OF DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more embodiments, the present disclosure relates to a system for tracking a position on a rig site that includes a plurality of static beacons of defined positions on the rig site configured to transmit reference signals at a selected triggering time for transmission; at least one moveable receiver at a first location on the rig site configured to receive the reference signals from the plurality of static beacons, determine the reception time of signal, and transmit reception information to a master node via a communication channel; wherein the master node is at a location on the rig site with a reference base time, wherein the master node receives the defined positions and reference times of the plurality of static beacons, and wherein the system is configured to, based on the reception information, determine signal travel times between the static beacons and the at least one moveable receiver, determine the distances between the static beacon and the at least one moveable receiver based on a travel time of the reference signals, and determine a position of the first location.

In one or more embodiments, the present disclosure relates to a method for tracking a position on a rig site that includes transmitting a plurality of reference signals at defined transmission times from one or more transmitters to one or more receivers, the transmitter and the receiver both being on a rig site, and one of the transmitter and receiver being fixed and of defined position and the other being disposed on a moveable rig equipment or person; transmitting reception information for the plurality of reference signals to a master node at a location on the rig site; determining an arrival time of the received reference signals for each receiver; determining a distance between the one or more transmitters and the one or more receivers; and determining a location of the movable rig equipment or person on the rig site.

In one or more embodiments, the present disclosure relates to a system for tracking a position on a rig site that includes at least one moveable transmitter at a first location on the rig site configured to transmit a reference signal; a plurality of static receivers of defined positions on the rig site configured to receive the reference signal from the moveable transmitter, determine the reception time of signal, and transmit reception information to a master node via a communication channel; and wherein the master node is at a location on the rig site with reference base time, wherein the master mode receives the defined positions and reference times of the plurality of static receivers, and wherein the system is configured to receive the reception information, determine signal travel times between the moveable transmitter and the static receivers, determine the distances between the moveable transmitter and the static receivers based on a travel time of the reference signal, and determine a position of the first location.

### BRIEF DESCRIPTION OF DRAWINGS

FIG. 1 illustrates a schematic view of a system for tracking a location according to one or more embodiments of the present disclosure.

FIG. 2 illustrates a schematic view of a receiver according to one or more embodiments of the present disclosure.

FIG. 3 illustrates a perspective view of a system for tracking a location a rig site of FIG. 1 according to one or more embodiments of the present disclosure.

FIG. 4 illustrates a side view of a system for tracking a location a rig site of FIG. 3 according to one or more embodiments of the present disclosure.

FIG. 5 illustrates a perspective view of a system for tracking a location on a rig floor of FIGS. 3 and 4 according to one or more embodiments of the present disclosure.

FIG. 6 illustrates a top view of a system for illuminating a location on a rig floor of FIG. 5 according to one or more embodiments of the present disclosure.

FIG. 7 illustrates a schematic view of a system for tracking a location according to one or more embodiments of the present disclosure.

### DETAILED DESCRIPTION

Embodiments of the present disclosure are described below in detail with reference to the accompanying figures. Like elements in the various figures may be denoted by like reference numerals for consistency. Further, in the following detailed description, numerous specific details are set forth in order to provide a more thorough understanding of the claimed subject matter. However, it will be apparent to one having ordinary skill in the art that the embodiments described may be practiced without these specific details. In other instances, well-known features have not been described in detail to avoid unnecessarily complicating the description.

Further, embodiments disclosed herein are described with terms designating a rig site in reference to a land rig, but any terms designating rig type should not be deemed to limit the scope of the disclosure. For example, embodiments of the disclosure may be used on an offshore rig. It is to be further understood that the various embodiments described herein may be used in various rig sites, such as land rig, drilling vessel, offshore rig, etc., and in other environments, such as work-over rigs, fracking installation, well-testing installation, oil and gas production installation, without departing from the scope of the present disclosure. The embodiments are described merely as examples of useful applications, which are not limited to any specific details of the embodiments herein. system for tracking a location a rig site.

Embodiments of the present disclosure may be directed to systems and methods for tracking a location at a rig site. That is, at a drilling rig location, beacons (i.e., transmitters) and receivers are installed at several places to transmit and receive signals and process the received signal to determine the arrival time of the received signal. In one or more embodiments, coded signals are transmitted by the beacons. Once the coded signals are transmitted, cross-correlation between received and transmitted signals allows to determine an arrival time of the signal at the receivers. From the arrival times, the travel times from the transmitter to the receivers can be determined. Furthermore, a master node at a fixed location on the rig site will calculate the locations of the beacons and receivers, which may be mobile units and/or fixed reference units, based on the travel time determined from the arrival time of the received signal. In one or more embodiments, the beacons are the fixed reference units with pre-defined known locations, while the receivers are on mobile units. Thus, when there are various components (rig equipment) and workers on the rig site, the master node is able to identify and track the locations of the mobile components and workers carrying the receivers. In conventional tracking operations, a global positioning system (GPS) may be used for continuous position tracking to track various rig equipment and workers on the rig site by using satellites. However, the rig may include several areas where determining the position of components and personnel by GPS would be incorrect due to indirect or scattered wave pattern or travel from the satellite. GPS typically needs a direct line of sight to the satellites to report accurate positions. Furthermore, the GPS positioning method may have limited accuracy due to even more multiple elements such as signal scattering by object in the travel path, or by multiple reflections, or by reception of signal from satellites at non-optimum positions in the sky, generating apparent jittering in the received signal, loss of signal, reducing the number of information for averaging after cross-correlation, or even reception of signal from only 3 satellites not allowing correction for time drift at receiver, E-mag wave perturbation, and reflection at walls making the correlation noisier. Further, in many instances, workers just use a manual log to keep the location of rig equipment or even the rig personnel or the workers simply use their memory. Additionally, in a lot of circumstances, radios or walky-talkies are used for workers to communicate back-and-forth with their locations. In contrast, embodiments of the present disclosure provide the locations of various rig equipment and workers at the rig site using a beacon, receiver, and master node without needing conventional GPS methods, thus presenting a significant time and accuracy improvement. Furthermore, the element of human error is further limited.

As discussed herein, the locations of rig equipment and workers is determined with beacon, receiver, and master node system at the rig site are all envisioned as being embodiments of the present disclosure. In one or more embodiments, the present systems and methods track the various components and personnel at a rig site with a relationship of transmitting beacons and receivers at the rig site. A position determination is obtained by a triangulation of waves transmitted by the beacons and detected by the receiver and associated signal processing, such as correlation to determine the wave arrival and its associated travel time. Such tracking may ensure proper safety guidelines are met, and the equipment and personnel are in the correct locations. In particular embodiments, electromagnetic waves may be used to locate the mobile unit. However, acoustic waves may also be used. In the case of acoustic waves, positioning techniques using acoustic wave have the benefit of longer time of flight as the acoustic speed through air is approximately 330 m/s; but the acoustic speed varies with air characteristics (e.g., temperature, humidity, etc.) and may introduces some inaccuracy in the calculation of distance. It is further envisioned that with an acoustic-based locating system, acoustic transmitters (e.g., loudspeaker) may be used and microphones for signal reception.

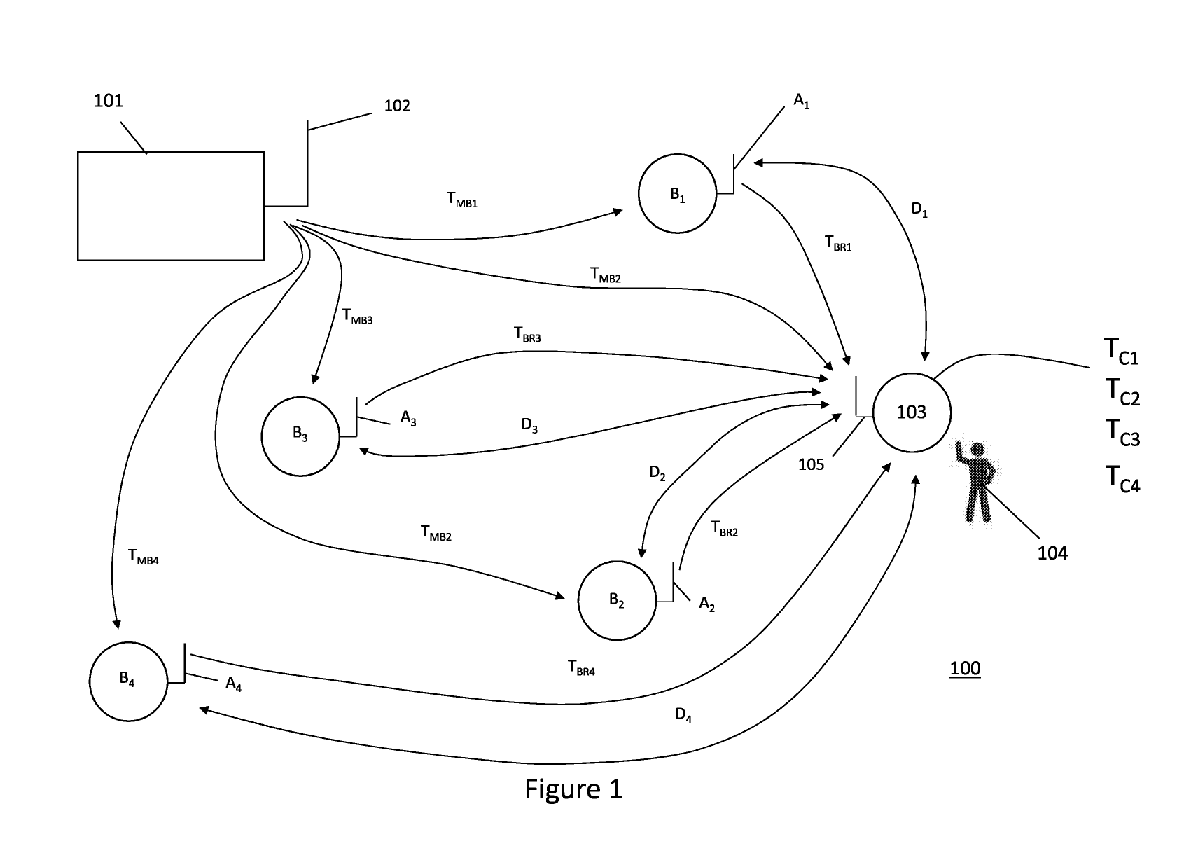

As seen by FIG. 1, a schematic view of a system for tracking a location of moveable (or moving) personnel or equipment is illustrated. A rig site 100 includes a master node 101 with a master node antenna 102 fixed at any location on the rig site 100. The master node 101 may also be incorporated into any housing (not shown) already at the rig site 100. For example, the master node 101 may be in a housing that runs the rig, such as a driller's control room (DCR), a power control room (PCR), or a local electrical room (LER), or a separate housing (i.e., the company man's quarters), or even in a specific dedicated container. Additionally, the master node 101 may be at a remote location on the rig site 100 and transmit data to any location. The master node 101 may be placed at any location where the master node antenna 102 can be placed at an elevated location to illuminate most of the rig. The electronics of the master node 101 are placed in close proximity to the master node antenna 102 given the high frequency signals, and most commonly in an enclosure or housing for the comfort of the optional person monitoring the computing and tracking being performed by the master node. In one or more embodiments, a plurality of static transmitters or beacons B₁, B₂, B₃, B₄, with each beacon B₁, B₂, B₃, B₄ having an antenna A₁, A₂, A₃, A₄, are installed at fixed and stable locations around the rig site 100. The beacons B₁, B₂, B₃, B₄ contain drive electronics in communication with its respective antenna A₁, A₂, A₃, A₄. In one more embodiments, the beacons B₁, B₂, B₃, B₄, may be physically connected to the master node by communication links (e.g., fiber optics or twisted copper pairs or coaxial cables, etc.); however, it is also envisioned that the beacons B₁, B₂, B₃, B₄ could also be wirelessly connected to the master node 101. The master node 101 is equipped with an antenna 102 to insure communication (e.g., two-way communication) with the mobile receiver(s) 103 and in some applications to some beacons. The beacons may transmit pulsed signals or coded signals. With pulsed signal, the signal may contain a minimum number of transmission cycles at a base frequency (e.g., high frequency). Furthermore, the coded signal may be a sweep of frequency, or digitally coded signal. In the case of digitally coded signal, the bit pattern may be superposed to a carrier frequency. The coding may be based of multiple frequencies or by phase encoding. Quadrature phase shift keying (QPSK) encoding may be one coding method. Beacons B₁ to B₄ may have their location sent to the master node 101. While four beacons B₁, B₂, B₃, B₄ are shown for example, it is further envisioned that the system is not limited to any set number of beacons but will generally have at least three beacons or a sufficient number based on the area of the rig site, as well as depending on whether triangulation is happening within two or three dimensions and whether all clocks are synchronized. The position of beacons B₁, B₂, B₃, B₄ may be determined by a surveying method such as theodolite (at least for their relative positions) or from a GPS system averaged over long time to obtained high resolution; however, conventional surveying methods may provide higher accuracy for the component relative positions. The beacons B₁, B₂, B₃, B₄ transmit a signal (for example, a coded signal) from a defined time reference. The use of a coded signal (varying between the beacons) may allow for the receiver to immediately recognize which beacon is transmitting a signal, allowing simultaneous transmission and superposed detections at a given time by a receiver. With none-coded signal, only one transmitter may transmit for a given time slot. Additionally, the transmission between the multiple transmitters must be distributed over time and adequately coordinated. Such time reference may be obtained from a GPS synchronized clock or the clock of the master node 101 which may transmit the reference time to the beacons B₁, B₂, B₃, B₄ via a network (not shown). However, delays may occur in the transmission of the reference time. This delay in the network may be determined so that each beacon B₁, B₂, B₃, B₄, may either correct for the time delay or the processing associated with received signal can include this delay.

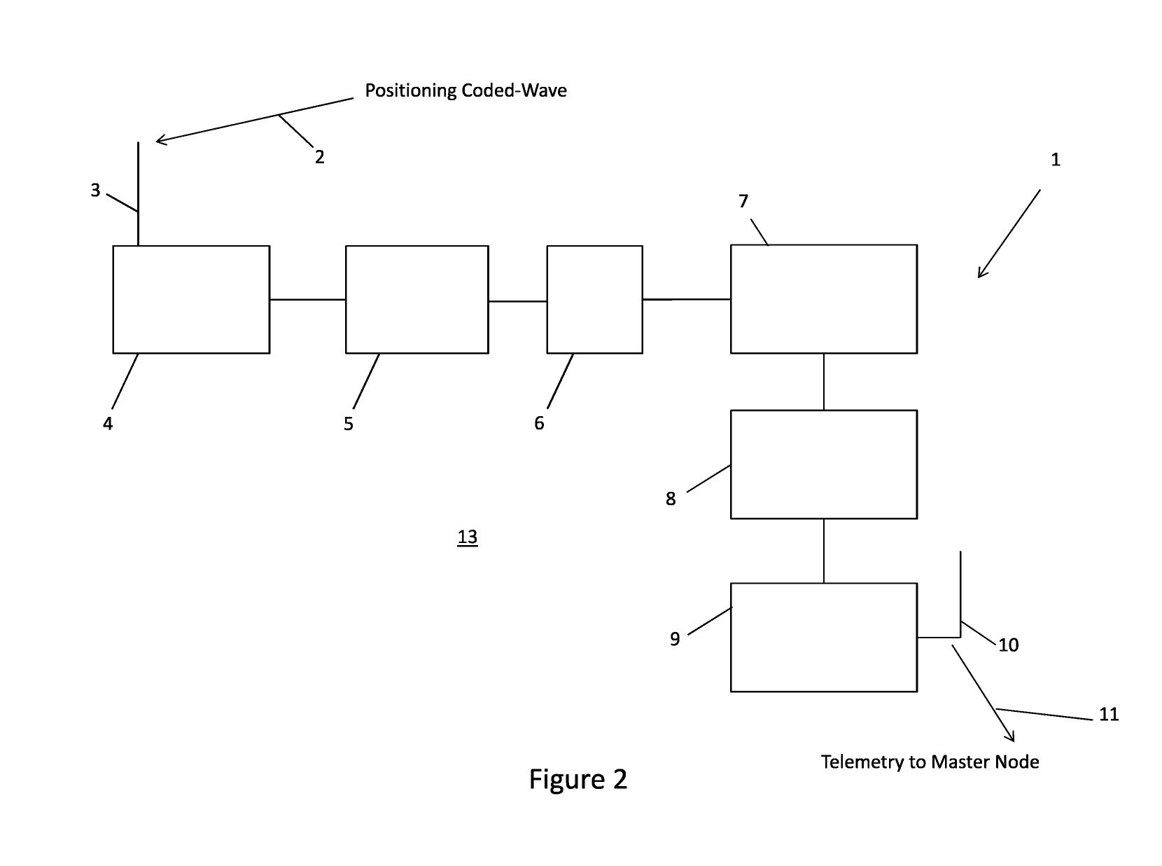

Still referring to FIG. 1, the master node 101 transmits a reference synchronization sequence at pre-defined intervals (not shown) to determine a unique clock reference without the beacons and the master node. One step of the synchronization sequence is to determine a propagation delay from the master node 101 and the beacon itself. For the aforementioned step, the master node sends a specific frame. When the beacon receives the specific frame, the beacon retransmits the specific frame immediately with a specific internal process involving no random delay. Typically, the specific internal process is performed by a low level layer of the network protocol stack involving field programmable gate array (FPGA) device with linear programming process to have no variation of the propagation delay offset generated within the beacons B₁, B₂, B₃, B₄, or any network nodes within the communication paths. The propagation delay, in a given node, (may also be called an internal delay or repeat internal delay) may have been characterized initially at the construction of the device. The master node 101 receives the retransmitted signal and measures a total time delay between its own transmission and the retransmitted signal. As such, the total time delay reduced by the propagation delay provides for “two-ways” time delay, and allows calculation of a “one-way” time delay. Furthermore, as a synchronization sequence, the master node transmits a reference synchronization frame which contains the reference time. The beacons B₁, B₂, B₃, B₄ receive the reference synchronization frame and determine the time corresponding to the beacons' B₁, B₂, B₃, B₄ reception of the reference synchronization frame, which is increased by the “one-way” time delay determined previously for this beacon, as seen by arrows T_{MB1}, T_{MB2}, T_{MB3}, T_{MB4}. The times T_{MB1}, T_{MB2}, T_{MB3}, T_{MB4} may be used by the master node 101 to synchronize the master node 101 and beacons B₁, B₂, B₃, B₄ to the same clock or reference base time of the master node 101. The aforementioned clock (i.e., same clock) may be a reference clock of the mater node 101 or a clock of absolute time. Such transmission may occur through the fiber optic network (or any other type of communication cables, such as a twisted pairs cable or coaxial cables), or the event of a wireless network, via radio, for example. Additionally, the master node 101 receives the location of the beacons B₁, B₂, B₃, B₄ at the rig site 100. The beacons B₁, B₂, B₃, B₄ transmit a coded signal of the defined time sequence or by triggering from the mater node 101. The transmitted signal travels to the receiver 103 with a travel time determined by the distance between the transmitter to receiver divided by the wave specific travel speed (such as 300,000 Km/s for EM wave through vacuum or air). The travel times may be as seen by arrows T_{BR1}, T_{BR2}, T_{BR3}, T_{BR4}. The defined time references T_{BR1}, T_{BR2}, T_{BR3}, T_{BR4} travel to a receiver 103 which will be described in detail in FIG. 2 disposed on a worker 104 at the rig site 100. The travel times T_{BR1}, T_{BR2}, T_{BR3}, T_{BR4} corresponds to the straight travel paths D₁, D₂, D₃, D₄ between the different transmitters B₁, B₂, B₃, B₄ and receiver 103. One skilled in the art will appreciate that by placing the receiver 103 on a worker 104, the receiver 103 may be movable. However, it is also envisioned that receiver 103 may be placed on moveable equipment rather than personnel such as worker 104. For example, the moving equipment may be a forklift, a crane, a delivery truck, and even a drilling-rig machine such as top-drive, components of the pipe handler or iron-roughneck. Further, moveable is intended to refer to personnel or equipment is regularly or periodically moving over the course of a rig operation. The tracking system may also be used for the installation or removal of the rig components during the partial or total move of the drilling rig. The object to be tracked can but does not necessarily need to be moving during the tracking. In one or more embodiments, the location of the mobile unit may be performed by goniometry. The goniometry technique involves the measurement of angles between the beacons and the receivers, in place of distance measurement. For example, when referring to three beacons for 2D location, the measurements at the receiver of angles between the beacons allows to determine, by trigonometry, the relative position of the receiver versus the beacon. Goniometry was the basic technical method behind conventional usage of theodolite (typically based on light or laser beams). The goniometry technique is quite accurate. Typically, the angle measurement requires the usage of directional receiving system (antenna) and a method to orient the directional antenna, associated with a method to measure the angle.

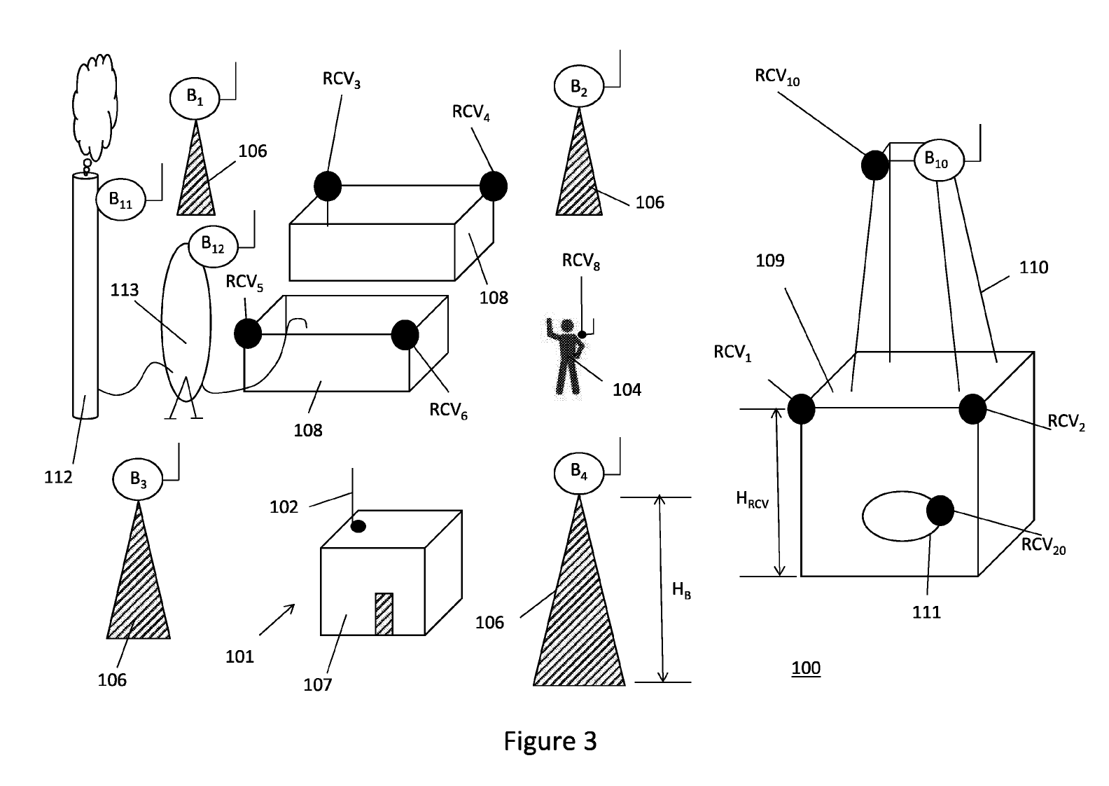

In one or more embodiments, one skilled in the art will appreciate how the receiver 103 may be placed anywhere in the rig site 100 as will be described in further detail in FIGS. 3-7.

Beacons B₁, B₂, B₃, B₄ send the specific electro-magnetic signals at the defined triggering time (Ttrig) for component positioning. As the clock in each beacon is synchronized with the clock of the master node 101, the beacons B₁, B₂, B₃, B₄ may transmit their corresponding signals at the requested trigger time. In one or more embodiments, all the beacons may transmit their coded signals from the same triggering time. It is further envisioned that only one beacon may transmit for a given triggering time. In such a case, the signals may not be based on a specific code per beacon. Such triggering time and process is defined and control by the master node 101. The receiving node (such as receiver 103) receives the transmitted signals by each of the beacons B₁, B₂, B₃, B₄. After the required signal handling and processing, the receiver 103 determines the arrival times Tc1, Tc2, Tc3, Tc4 for each of the transmitted signals by the different beacons B₁, B₂, B₃, B₄. Said determination may be obtained by cross-correlation process of the selected reference signal and the received signal for each beacon B₁, B₂, B₃, B₄. The travel of the waves from the beacons to the receiver covers a straight distance D₁, D₂, D₃, D₄ and requires the time of flight T_{BR1}, T_{BR2}, T_{BR3}, T_{BR4}. The time of flight T_{BR1}, T_{BR2}, T_{BR3}, T_{BR4} are obtained as the difference between the reception time Tc1, Tc2, Tc3, Tc4 and the trigger time Ttrig. The aforementioned difference may be calculated either in the master node 101 or in the receiver 103. In order to cross-correlate the coded signal patterns sent from beacons B₁, B₂, B₃, B₄, the pattern may be pre-selected and stored in memory of the receiver 103 or when the receiver 103 is turned on, the receiver 103 may communicate with the master node 101 and receive the patterns of the beacons B₁, B₂, B₃, B₄ from the master node 101. Additionally, the receiver 103 performs the cross-correlation of the detected signal versus the pattern of the signal transmission for various time offset, allowing to determine the correlation factor peak versus the time offset The time offset corresponding to the correlation peak is selected at the arrival or reception time T_{c1}, T_{c2}, T_{c3}, T_{c4}. The reception times T_{C1}, T_{C2}, T_{C3}, T_{C4} are transmitted to the master node 101 thanks to the antenna 105 of receiver. The master node 101 may calculate the times of flight T_{BR1}, T_{BR2}, T_{BR3}, T_{BR4} between the beacons T_{BR1}, T_{BR2}, T_{BR3}, T_{BR4} and the receiver 103 by subtracting the triggering time (Ttrig), and thus, obtain the travel time. Then the distances D₁, D₂, D₃, D₄ between the beacons B₁, B₂, B₃, B₄ and receiver 103 may be obtained by multiplying the times of flight T_{BR1}, T_{BR2}, T_{BR3}, T_{BR4} by the wave propagation velocity (such as 300,000 Km/s for EM wave) for calculation of the position of the receiver 103.

As described above, the master node 101 gains knowledge of the reception time T_{C1}, T_{C2}, T_{C3}, T_{C4}, the times T_{MB1}, T_{MB2}, T_{MB3}, T_{MB4}, and the defined time references T_{BR1}, T_{BR2}, T_{BR3}, T_{BR4}. With the master node 101 knowing the aforementioned times, the master node 101 will determine a distance D₁, D₂, D₃, D₄ from the receiver 103 to the beacons B₁, B₂, B₃, B₄. Upon the master node 101 knowing not only the locations of beacons B₁, B₂, B₃, B₄ but also the distances D₁, D₂, D₃, D₄, the master node 101 may determine a location of the receiver 103 at the rig site 100. Additionally, one skilled in the art will appreciate how the processing related to positional tracking may be all performed at the master node 101. Further, it is also envisioned that such processing may occur at the receiver 103; however, such local calculation and processing would still need to communication the results to the master node 101 in order for the position of receiver 103 to be monitored. Calculation at the master node 101 may allow for a smaller and more power efficient receiver to be used.

The beacons B₁, B₂, B₃, B₄ may be fixed around the rig site 100 to provide two-dimension (2D) and/or three-dimension (3D) positioning. If only 2D positioning is desired, the beacons B₁, B₂, B₃, B₄ may be installed at a similar elevation above a “ground level” of the rig site 100. In such case, the receiver should receive at least signal from three beacons. Additionally, on drilling rig site 100, at least one beacon B₁, B₂, B₃, B₄ is installed at high altitude such as disposed on a high elevation such as mast (i.e., at a top of the mast) or the flare stack or the Mud-gas separator or even on specific support structures to perform 2D positioning at high altitude or to perform 3D positioning (with the presence of a fourth beacon). Furthermore, during installation of various rig components, the beacons B₁, B₂, B₃, B₄ may only be fixed near the ground level as high altitude positioning may be unavailable. As such, until larger equipment becomes available for the beacons B₁, B₂, B₃, B₄ to be fixed, only 2D positioning may be available. However, this is commonly sufficient to position the rig components in relation to each other; such as central package versus the well desired position, the large skids and mud tanks in relation to the central package. In the case of 3D positioning, the beacons B₁, B₂, B₃, B₄ may be fixed at both low and high altitudes to collectively work together and create a 3D positioning. Additionally, it is also envisioned that during rig setup (when “permanent” high elevations are not available), that “temporary” beacons may be placed on temporary structures (such as balloons) in order to provide triangulation in the third dimension. One skilled in the art will appreciate how having a beacon at a high elevation allows for the beacons to advantageously perform positioning in both 2D and 3D. The positions of the beacons (temporally or permanent) must be known at any moment to allow the relative positioning of a receiver. If the beacon is mounted on a variable position support (such as a balloon), the beacon may have to be equipped with a GPS antenna to continuously determine the position of the beacon.

Now referring to FIG. 2, according to one or more embodiments, a schematic view of a receiver 1 in the present disclosure is shown. As described above, the receiver 1 may be attached to a movable object; however, in other embodiments, the receiver may also be fixed at a rig site 13, as discussed below. A beacon (not shown) sends a positioning coded-wave electro-magnetic signal 2 (referred to hereinafter as the received signal 2) to an antenna 3 of receiving electronics 4 in the receiver 1. The antenna 3 allows for the reception of the received signal 2. From the receiving electronics 4, the received signal 2 is cleaned with a filter amplifier 5, specifically to filter and/or amplify the signal 2. Once cleaned and filtered, the received signal 2 is now digitalized by an analog-to-digital converter 6. Upon digitalization of the received signal 2, a digital correlator 7 will cross-correlate the received signal 2 versus all coded signal references being sent from a plurality of active beacons, such as in FIG. 1, to determine which beacon matches the received signal 2 and also to determine the arrival time corresponding to the correct code found by the digital correlator 7. A field-programmable gate array, a digital application-specific integrated circuit, a digital signal processor unit, or a processor may perform such correlation. Upon knowing the arrival time, a radio transmitter 9 in the receiver 1 sends the arrival time to master node 11 via an antenna 10 through telemetry. While two antennas 3, 10 are shown in this figure, one skilled in the art will appreciate that receiver 1 is not limited to two antennas and may only use one antenna or any amount of antennas. Additionally, one skill in the art would understand that components of the receiver 1 described above are a part of a digital processor (such as field-programmable gate array, digital application-specific integrated circuit, digital signal processor unit, or processor), and that variations on such digital processor may be envisioned without departing from the scope of the present disclosure.

FIG. 3 illustrates a perspective view of a system for tracking a location of objects at a rig site according to one or more embodiments of the present disclosure. A master node 101 with antenna 102 is fixed at a location on the rig site 100. As discussed above in FIG. 1, the master node 101 may be incorporated into any housing 107 already at the rig site 100. The housing 107 may be understood to one of ordinary skill to be any housing typically required at the rig site or housing specific to the master node 101. Further illustrated in in FIG. 3, the worker 104 is positioned at the rig site 100. The worker 104 has a receiver RCV₈ which can be worn or intergraded into any piece of personal protection equipment (PPE). Because receiver RCV₈ is located on worker 104, receiver RCV₈ is moveable. One worker 104 is shown for simplicity purposes; however, it would be understood that rig site 100 may have a plurality of workers at the rig site 100 or personnel visiting the rig site 100, with each worker/personnel carrying or wearing their own receiver. Additionally, the rig site 100 may have a plurality of receivers RCV₁, RCV₂, RCV₃, RCV₄, RCV₅, RCV₆, disposed around the rig site 100 that are static. By static, it is intended that the receiver is in a fixed location for a period of time, for example, over the course of several days. In such a situation, the receiver in the fixed location may be present for devise associated with the central package of a skidding or walking rig (e.g., the central package with the rig floor and mast, the catwalk, the shaker skid, the rig choke manifold, etc . . . . ). In one or more embodiments, the receivers may be placed on rig mobile elements (e.g., mobile parts of the pipe-handler, top-drive, etc . . . . ) That is, the receivers may be installed on rig equipment that, once set in place, is generally left in such place over the course of rig operations. However, it is also envisioned that such equipment may move during the course of the operations, and if moved, such movement would need to be taken into account and sent to master node 101. For example, the receivers RCV₃, RCV₄, RCV₅, RCV₆, may be disposed on mud tanks 108, and the receivers RCV₁, RCV₂, may be disposed on a rig 109. Additionally, a high receiver RCV₁₀ may be disposed on a rig mast 110 to be at a higher altitude than any other receiver RCV₁, RCV₂, RCV₃, RCV₄, RCV₅, RCV₆, RCV₈ at the rig site 100. One skilled in the art will appreciate that a height H_{RCV} of the static receivers RCV₁, RCV₂, RCV₃, RCV₄, RCV₅, RCV₆, RCV₁₀, may vary for the various components (i.e., rig equipment) of the rig site 100. Furthermore, a well receiver RCV₂₀ may be positioned at a well 111 of the rig site 100. With the well receiver RCV₂₀, a well position is also able to be determined using the methods described in FIGS. 1 and 2 or by surveying method. It is further envisioned that the well receiver RCV₂₀, associated with its own position obtained by conventional surveying method, may be used to confirm proper capability of determining locations when using the system for tracking a location of objects at a rig site.

Still referring to FIG. 3, FIG. 3 also illustrates that beacons B₁, B₂, B₃, B₄ are fixed on towers 106 around the rig site 100. As mentioned above, it is further envisioned that the beacons may be fixed to a balloon during the initial set-up of the rig site and/or during the duration of the rig site's life. The balloons may be filed with any gas (preferably Helium) to allow the beacons to be at an elevated elevation. Additionally, the balloons may be fitted with a cable to anchor the balloon to insure its location in the proximity of the anchoring point. Furthermore, the balloon may be equipped with a GPS receiver to continuously update accurately its 3D position. The beacon on the balloon may communicate with the master node either via cable or wireless. The towers 106 can be various heights H_{B}. The heights H_{B} of the towers 106 may be determined on an individual basis with the needs of the rig site 100. Additionally, it is further envisioned that the towers 106 may be an adjustable height and be changed in real time at the rig site 100. Furthermore, additional beacons B₁₀, B₁₁, B₁₂ may be installed on various other components (i.e., rig equipment) of the rig site 100. For example, the beacon B₁₀ may be disposed on the rig mast 110, the beacon B₁₁ may be disposed on a flare stack 112, and the beacon B₁₂ may be disposed on a mud-gas separator (MGS) 113. One skilled in the art will appreciate how the beacons B₁, B₂, B₃, B₄, B₁₀, B₁₁, B₁₂ are not limited to be disposed on to one fixed point and may be moved as needed. However, if the beacons are moved, the new location of the beacons would be conveyed to the master node 101. Because surveying methods (such as theodolite) may provide more accurate positioning than GPS, moving beacons may be less desirable if the new position information relies on GPS. However, it is appreciated that in some instances, moving the beacons may be unavoidable. By fixing the master node 101 and having the static receivers RCV₁, RCV₂, RCV₃, RCV₄, RCV₅, RCV₆, RCV₁₀, and static beacons B₁, B₂, B₃, B₄, B₁₀, B₁₁, B₁₂ around the rig site 100, tracking the location(s) of moveable rig equipment or rig personnel such as worker 104 with receiver RCV₈ using triangulation is possible.

Additionally, it is also envisioned that to manage the tracked locations, various equipment may be grouped together. For example, the large rig components (such as mud tanks 108, rig 109, housing 107, MSG 113, high valued equipment, etc.,) may be geometrically described in a database for each component. As such, the database includes the position of the receivers installed on these large rig components. Furthermore, a site map (not shown) may be provided to locate the position of the well 111 at the rig site 100. Additionally, a planned site map may be used to show what plan will be used to set up the rig site and equipment with receivers 103 may be placed in accordance with the plan, and their positions tracked versus the planned site map via the beacons B₁, B₂, B₃, B₄ fixed either on towers 106 or “temporary” structures such as balloons to allow for more accurate placement of rig equipment in accordance with a planned site map. For example, as a skid is being driven onto the site, if the skid is being taken the wrong locations according to the plan, a worker may radio the driver to inform the driver of the correct location. It is further envisioned that the final site map may deviate from the planned site map if needed for any reason (i.e., weather, well conditions, different job requirements, etc . . . ). Furthermore, once the rig equipment is installed, the final site map may be finalized and may be used as the map on which the location of moveable equipment/personnel are tracked by the master node. The planned and final site map may be available via the master node 101 or through other secured locations for authorized use. The well 111 may already exist or may have to be drilled, and the rig site may contain a plurality of wells. Additionally, the final site map may include the positions of the beacons and one (or multiple) rig layout may be provided to describe the relative position of the rig components between themselves. The rig components are tracked and positioned on the site map, such as by using reception antennas of the receivers RCV₁, RCV₂, RCV₃, RCV₄, RCV₅, RCV₆, RCV₈, RCV₁₀ properly positioned on the rig components to receive the signal form the beacons B₁, B₂, B₃, B₄, B₁₀, B₁₁, B₁₂ or by conventional surveying methods. With such information management (i.e., the site map), it may be possible to support the proper arrangement process for rig components after the rig 109 moves, as well as during any rig 109 walk process.

As discussed above, 2D positioning may be used for the rig components from signals from the beacons at a low altitude. However, large equipment may create shadows and thus, the beacons B₁, B₂, B₃, B₄, B₁₀, B₁₁, B₁₂ and the receivers RCV₁, RCV₂, RCV₃, RCV₄, RCV₅, RCV₆, RCV₈, RCV₁₀ may be placed at sufficient elevation, as seen by H_{B} and H_{RCV} in FIG. 3, to limit the occurrences of shadows. Furthermore, when the tall components (such as the rig mast 110 and the flare stack 112) have been installed, then beacons and receivers (i.e., RCV₁₀, B₁₀, B₁₁) may be positioned at high altitudes available for positioning operation. Furthermore, 3D positioning can be used (low altitude and high altitude beacons) which may reduce the “shadow” areas behind large rig components.

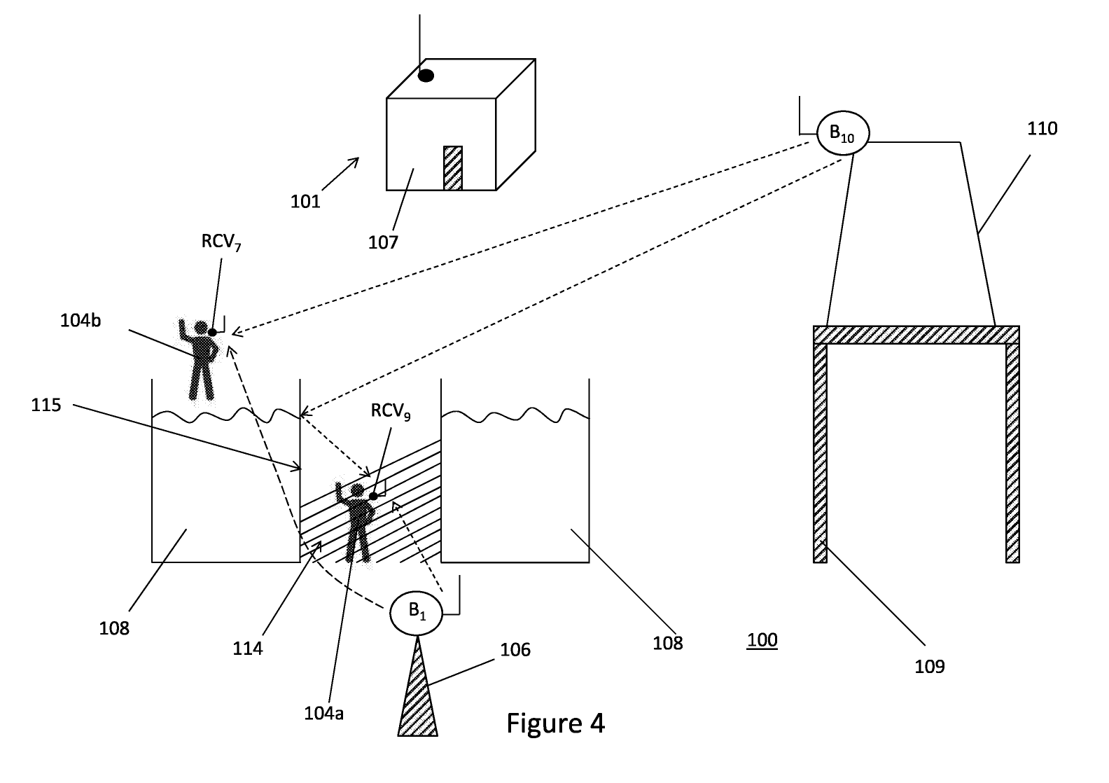

As shown by FIG. 4, FIG. 4 illustrates the mud tanks 108 creating a shadow 114. Once the locations of the large rig components are included in the site map of the rig site 100, “reflectors” (i.e., reflective surfaces present on rig equipment, for example) may be obtained from the site map. The reflectors may be a reflective surface 115 that is a well-defined surface of a large component, such as any large flat surface of the mud tank 108 or housing 107. The reflective surface 115 positions may be obtained from the database of the rig components logged by the master node. With knowledge of the location of the reflective surface 115, the beacons (such as B₁ and B₁₀) may use the reflective surface 115 to bounce the positioning signal (e.g., a coded-wave electro-magnetic) to determine a position of any receiver in the shadow 114 (or to use the knowledge of reflective surface 115 as well as the placement of tank 108 to understand that the receiver RCV₉ is not within the tank, but that the signal has reflected off of reflective surface 115 and thus receiver RCV₉ is outside of tank). For example, the combination of the 3D positioning and the reflective surface 115 allow the master node 101 to determine the position of a worker 104a with a receiver RCV₉ standing or moving in the shadow 114, standing between rig components, and a worker 104b with a receiver RCV₇ standing above the mud tanks 108. It is further envisioned that 3D positioning may be improved by converting the rig map into a 3D rig map, by defining additional surfaces such as the top flat surface of tanks, the rig floor, catwalk, and inclined slide surface as well as external stairs. The aforementioned elements may be obtained from the geometrical definition of the rig components in the database. One skilled in the art will appreciate how the site map and the component geometrical database may determine shadow and hidden areas in the rig site 100. Additionally, when a tracked object reaches such location, the object's last position will be saved. By saving the object's last position, the tracked object will be “determined” as inside the corresponding shadow and hidden areas.

In one or more embodiments, the various rig components, as described in FIGS. 3 and 4, which are supposed to be “static” may be tracked to confirm and determine their position versus time. For example, a top of the mast 110 is tracked to insure that there is no subsidence of the ground below the rig 109 during some drilling or well construction phases. As seen by FIG. 3, the receiver RCV₁₀ disposed on the mast 110 may determine a change of distance to the beacons B₁, B₂, B₃, B₄, disposed on the towers 106 to determine any abnormal change of position of the top of mast 110. Such abnormal change could be related to ground subsidence due to ground compaction under high rig load, weather conditions, and various other elements. Additionally, the top of the mast 110 may flex or sway, and the flex may also be induced every time that the mast 110 is supporting a load in the well 111. The flex of the mast 100 may be induced by elastic deformation of the mast 110 and the rig 109. It is further envisioned that the flex of the mast 110 may be tracked at the rig-floor itself by installing a receiver at the edge of the rig floor, such as the receivers RCV₁, RCV₂ seen in FIG. 3. Furthermore, in the scenario that the rig 109 is moving or walking, the rig components may be tracked to insure that the overall rig 109 walk is performed according to a predetermined plan. For example, a center of the rig 109 will be tracked to insure that it is at the proper location after the walk (i.e., over the wellhead), so that a new well or further stage of a prior well (not shown) will be drilled with the rig at a desired (and centered) location. Additionally, it is further envisioned that during rig walk, various rig components may be tracked simultaneously to insure that the displacement of various large components is synchronous so that interconnections between components may not have to be fully broken or disconnected. As the receivers are movable and able to be disposed on the worker 104 (or equipment), the worker 104 is also tracked during the rig 109 moving from well to well.

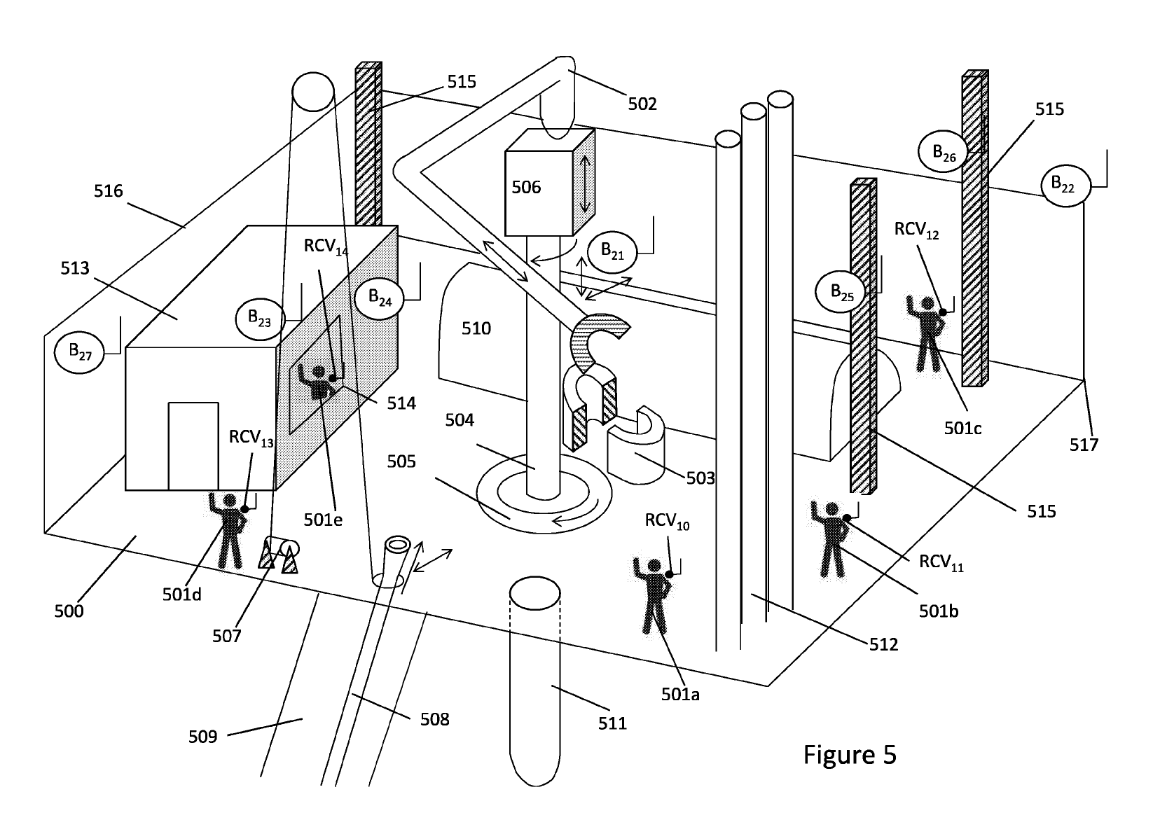

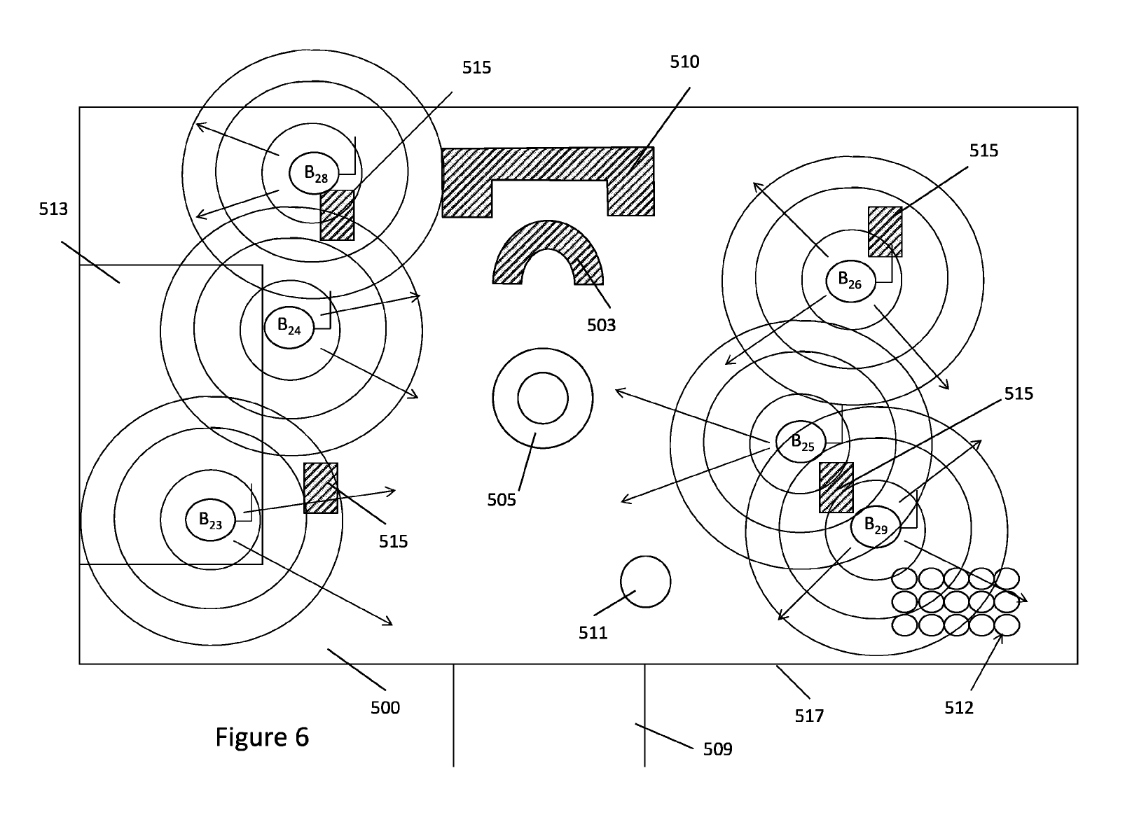

Now referring to FIGS. 5 and 6, in one or more embodiments, a rig floor 500 of the rig described in FIGS. 3 and 4 is illustrated. At the rig floor 500, it is quite important to know a location of a variety of rig personnel 501a-e, as the rig floor 500 has several mobile machines, heavy machinery, and safety regulations which should be met. Specifically, the rig floor 500 may be filled with a plurality of rig equipment known in the art, such as, a pipe handler 502, an iron roughneck 503, a drill sting 504, a rotary table 505, a top drive 506, a winch 507, a pipe 508 in an inclined slide 509, a plurality of mast legs 515, and a drawwork 510. However, one skilled in the art would understand the present disclosure is not limited to the just the various rig equipment shown in FIG. 5 without departing the present scope of the disclosure. In addition to such equipment, some rig areas such as a mouse hole 511 and pipe in a setback 512 may also be a source of risks for the rig personnel 501a-e. The aforementioned rig equipment on the rig floor 500 is typically controlled by the rig personnel 501e in a control room 513. In some cases, the rig equipment is manual controlled by the rig personnel 501a-e. However, since the rig personnel 501e is in the control room 513 and there are various equipment disposed around the rig floor, blind spots are created from a window 514 of the control room 513 for the rig personnel 501e to see out of As such, in one or more embodiments, several beacons B₂₁₋₂₉ may be installed around the rig floor 500 on various equipment, as shown in FIGS. 5 and 6, to illuminate the rig floor 500 with electro-magnetic wave signals (see the circles with the arrows surrounding the beacons shown in FIG. 6). In one or more embodiments, the beacons B₂₁₋₂₉ may be located at an elevation of 5 to 10 feet from the rig floor 500. Nevertheless, the beacons B₂₁₋₂₉ are not limited to the elevation of 5 to 10 feet and may be at any height required for coverage the rig floor 500. Additionally, one of the beacons B₂₁₋₂₉ may also be mounted on a wind wall 516 or upper edge of a rig fence 517. Further seen by FIGS. 5 and 6, beacons B₂₁₋₂₉ may be disposed on the plurality of mast legs 515 at certain elevations to reduce shadow and hidden areas, as well as improving the determination of vertical position of a receiver RCV₁₀₋₁₄ on the rig personal 501a-e. By illuminating the rig floor 500 with the beacons B₂₁₋₂₉, the master node (as described in FIGS. 1-4) may determine when the receiver RCV₁₀₋₁₄ of the rig personnel 501a-e enters the area illuminated by the beacons B₂₁₋₂₉. With the knowledge of where the rig personnel 501a-e are located on the rig floor 500 relayed back to the main activity supervisor (e.g., the tool-pusher or the driller) 501e, the work is allowed to be safely done. Further, it is also envisioned that the tracking of rig personnel may be coupled with an alarm system that notifies the appropriate parties if a person is ever or regularly stepping into a zone that is unsafe or inappropriate for the particular worker, such as due to heavy equipment, gas emissions, etc. It is further envisioned that the alarm related personnel tracking may also be coordinated in relation to the qualification and training of said person. For example, a person may enter in a given are of specific hazard only if that person has received the specific training (e.g., entering in hazardous zone to flammable or toxic gas). Additionally, tracking may also occur above rig floor (in the air) as well as under the rig floor, in addition to on the rig floor.

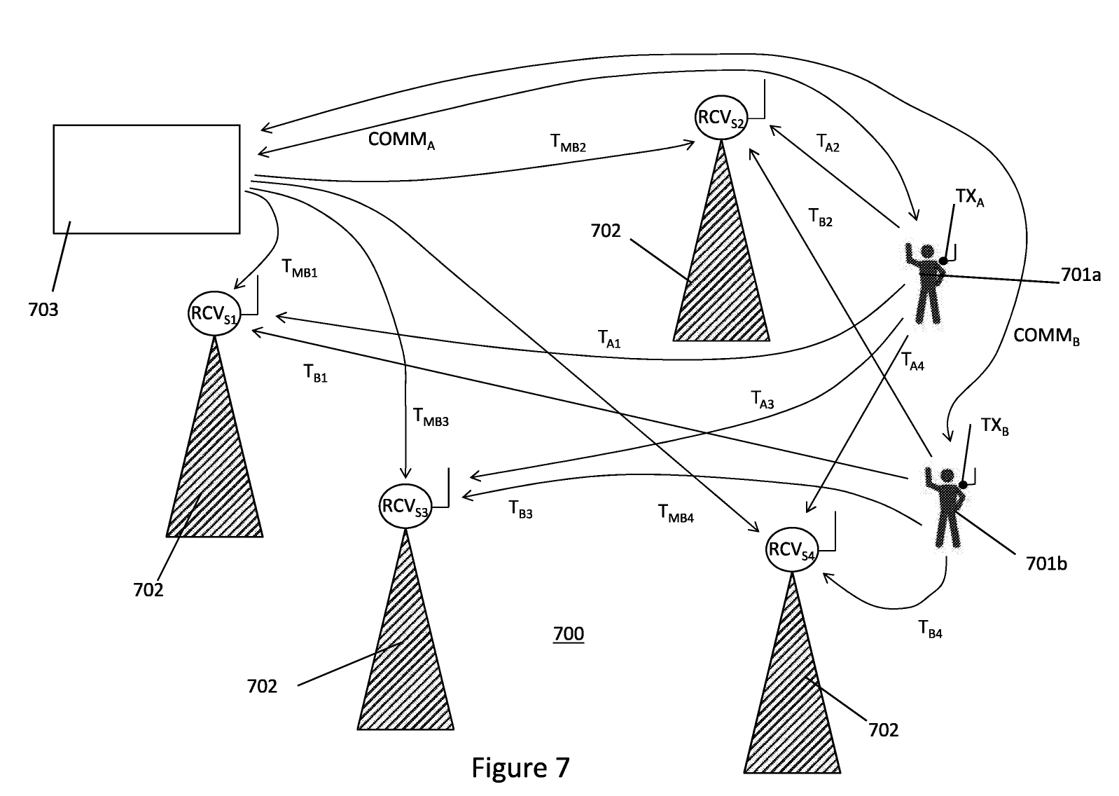

With regards to FIG. 7, in one or embodiments, another embodiment of a configuration of the tracking system is shown. As illustrated above, the moving personnel and/or equipment carry receivers in order to track their positions, while the transmitting beacon is static. However, it is envisioned that the reverse may also be implemented, where the moving personnel and/or equipment carries a transmitter and the receivers are static. As seen by FIG. 7, the personnel 701a, 701b at the rig site 700 each have a movable transmitter TX_{A}, TX_{B}. A plurality of static receivers RCV_{S1}, RCV_{S2}, RCV_{S3}, RCV_{S4} are on disposed on fixed towers 702. Additionally, the receivers RCV_{S1}, RCV_{S2}, RCV_{S3}, RCV_{S4} may be connected as a network to a master node 703 by either a cable or wireless communication system. Furthermore, the master node 703 is shown to be at a fixed location at the rig site 700. The network delay between the master node 703 and the receiver may be measured. The master node 703 sends a frame allowing to determine the time delay, as seen by arrows T_{MB1}, T_{MB2}, T_{MB3}, T_{MB4}, to the plurality of static receivers RCV_{S1}, RCV_{S2}, RCV_{S3}, RCV_{S4} to determine a time difference between a true synch time defined by the master node 703. The master node 703 may also send the synchronization frame to finally determine the correct true time for the clock of each receiver, including the pre-determined delay time T_{MB1}, T_{MB2}, T_{MB3}, T_{MB4}. Additionally, the master node 703 also communicates with the movable transmitters TX_{A}, TX_{B} via radio mode (such as WIFI). By communicating with the movable transmitters TX_{A}, TX_{B} the master node 703 may insure clock synchronization of these movable nodes and insures some coordination between the movable beacons TX_{A}, TX_{B} to avoid simultaneous start of transmission or to allocate specific code reference for the transmitted encoded signals. Furthermore, one skilled in the art will appreciate how the time coordination between the movable transmitters TX_{A}, TX_{B} does not need to be 100% accurate. As such, receivers are used to allow redundant detection of signals, and thus, allowing to process the geometrical position of corresponding transmitter and also solving the set of available measurements for the time reference of corresponding transmitter. Thus, when the movable transmitters TX_{A}, TX_{B} send a coded electromagnetic signal, the plurality of static receivers RCV_{S1}, RCV_{S2}, RCV_{S3}, RCV_{S4} receive the electromagnetic signal associated with specific travel time (as represented by the arrows TX_{A1}, TX_{A2}, TX_{A3}, TX_{A4}, TX_{B1}, TX_{B2}, TX_{B3}, TX_{B4}). Applying proper signal detection method (e.g., cross-correlation versus the reference codes), the master node 703 may determine the corresponding travel time of the wave and finally calculates the distance between the transmitter and the receivers. After determining more than three distances between a movable node and the receiver(s), the master node 703 may solve the 3D position and the start of transmission time at the movable transmitters TX_{A}, TX_{B}. Further shown in FIG. 7, to allow proper correlation at the plurality of static receivers RCV_{S1}, RCV_{S2}, RCV_{S3}, RCV_{S4}, the movable transmitters TX_{A}, TX_{B} may send a reference signal (see arrows COMMₐ and COMM_{B}) for correlation via a communication mode from the movable transmitters TX_{A}, TX_{B} to the master node 703. It is further envisioned that the movable transmitters TX_{A}, TX_{B} may use a standard WIFI transmitter to be worn by the personnel 701a, 701b at a rig site 700. Additionally, one with ordinary skill in the art would understand that the transmitted frame for a position of the movable transmitters TX_{A}, TX_{B} may be additionally based on a proper orthogonal coding as defined by mathematics so that there is separation of the cross-correlation results and optimum determination of the corresponding arrival time from each transmitter. Thus, in FIG. 7, the receivers are static whereas the transmitters are moveable. Such reversed scenario may be used in any of the above described embodiments (FIGS. 1 and 3-6) without departing from the scope of the present disclosure. Further, in order to determine orientation as well as location, two devices (transmitters or receivers) may be installed or worn on the object to be tracked.

For example, in the embodiments described in FIG. 1-7, it may be useful to determine the orientation of the moveable person versus a fixed station. However, a person may have a small horizontal coverage as compared to some larger rig equipment. Because of such small horizontal coverage between two devices, it may be difficult to determine its orientation (azimuth). Thus, in such an instance, in one or more embodiments, the worker may wear a device so that their body creates a shield between wearing two receivers or transmitter. For example, the worker may carry on a first receiver or transmitter on a front side of the worker's body as well as a second receiver or transmitter on a back side of the worker's body. In such an embodiment, only the receivers or transmitters disposed around rig the site forward to the worker will receive signal from the first receiver or transmitter (as the device acts a shield and a limited signal is transmitted backward). The signals from the second receiver or transmitter on the worker's back would be detected mainly by the static receivers and transmitters.

In the above described embodiments, the carrier frequency for electromagnetic waves used for the signal transmission may range from 0.7 to 5.0 GHz so that the wavelengths are relatively short. Such range overlaps with conventional electronics (such as Bluetooth at 2.4 GHz, Wi-Fi at 2.5 to 5 GHz, or mobile phones at 0.7 to 2.7 GHz), and thus, the availability of devices are relatively available.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for tracking a position on a rig site, comprising:
a plurality of static beacons of defined positions on the rig site configured to transmit reference signals at a selected triggering time for transmission;
at least one moveable receiver at a first location on the rig site configured to receive the reference signals from the plurality of static beacons, determine the reception time of signal, and transmit reception information to a master node via a communication channel; and
wherein the master node is at a location on the rig site with a reference base time, wherein the master node receives the defined positions and reference times of the plurality of static beacons, and
wherein the system is configured to, based on the reception information, determine signal travel times between the static beacons and the at least one moveable receiver, determine the distances or angles between the static beacon and the at least one moveable receiver based on a travel time of the reference signals, and determine a position of the first location.

2. The system of claim 1, wherein the moveable receiver comprises:
a receiving electronic having a receiving antenna that receives the reference signal;
a field-programmable gate array, or a digital application-specific integrated circuit, or a digital signal processor unit, or a processor configured to correlate the received reference signal into the reception time information; and
a radio transmitter configured to transmit the reception information to the master node.

3. The system of claim 2, wherein a signal arrival time is determined by the master node based on the reference signal by cross-correlation or by pulse detection.

4. The system of claim 2, further comprising a specific signal processing method to determine a signal arrival time.

5. The system of claim 4, wherein the reference signal is a coded signal over a carrier sinewave, and a determination of an arrival time is performed by cross-correlation versus the transmitted signal versus different time shift.

6. The system of claim 4, wherein the reference signal is a short burst of a few base transmission cycles and the determination of the received burst may be on a received energy in a short time window.

7. The system of claim 1, wherein each of the plurality of static beacons and the at least one moveable receiver have access to the reference base time of the master node.

8. The system of claim 7, further comprising a network extending between the plurality of static beacons and the master node to synchronize the plurality of static beacons and the master node to the reference base time.

9. The system of claim 1, wherein the moveable receiver is disposed on rig equipment or a person.

10. The system of claim 1, wherein at least some of the plurality of static beacons are installed at the defined positions independent from the rig equipment.

11. The system of claim 1, wherein at least one of the plurality of static beacons is installed at a higher elevation than the other of the plurality of the static beacons.

12. The system of claim 1, further comprising:
a plurality of static receivers disposed on a plurality of static rig equipment, wherein the master node is configured to map the rig site based on determined positions of the plurality of static rig equipment.

13. The system of claim 12, wherein the plurality of static beacons are selected and positioned to illuminate substantially all of the rig site either directly or by reflection.

14. The system of claim 13, wherein the plurality of static rig equipment includes a reflective surface, and wherein the master node accounts for reflection of the reference signal when determining the position of the first location.

15. The system of claim 1, wherein the plurality of static beacons comprises a plurality of zones to illuminate a rig floor of the rig site and detect when the moveable receiver is in the plurality of zones.

16. The system of claim 1, wherein the reference signal further compromises a wave that is coded over a sinusoidal signal or a short pulse.

17. The system of claim 1, wherein the wave is electromagnetic or acoustic.

18. The system of claim 17, wherein the electromagnetic wave is in the frequency range of 0.7 to 5 Gigahertz.

19. The system of claim 1, wherein the plurality of static beacons is installed at a plurality of locations on a rig floor and on a mast.

20. A method for tracking a position on a rig site, comprising:
transmitting a plurality of reference signals at defined transmission times from one or more transmitters to one or more receivers, the transmitter and the receiver both being on a rig site, and one of the transmitter and receiver being fixed and of defined position and the other being disposed on a moveable rig equipment or person;
transmitting reception information for the plurality of reference signals to a master node at a location on the rig site; and
determining an arrival time of the received reference signals for each receiver;
determining a distance or angle between the one or more transmitters and the one or more receivers; and
determining a location of the movable rig equipment or person on the rig site.

21. The method of claim 20, further comprising:
fixing a plurality of static beacons on the rig site configured to transmit the plurality of reference signals to the receiver; and
receiving the reference signals by a movable receiver at a first location on the rig site.

22. The method of claim 20, further comprising:
fixing a plurality of static receivers on the rig site configured to receive the plurality of reference signals from a movable transmitter; and
transmitting the reference signals by the movable transmitter at a first location on the rig site.

23. The method of claim 20, further comprising:
producing a time coded-wave through an antenna to a receiving electronic;
converting the time coded-wave from analog to digital; and
transmitting the time coded-wave through a radio transmitter to the antenna.

24. The method of claim 20, further comprising fixing a plurality of static receivers on a plurality of static rig equipment, determining a position of the plurality of static rig equipment, and mapping the rig site with the master node from the determined position of the plurality of static rig equipment.

25. The method of claim 24, further comprising accounting for a reflection of the reference signal on a reflective surface of at least one static rig equipment.

26. The method of claim 24, further comprising illuminating the rig site by producing a plurality of zones with a plurality of static beacons and detecting when a moveable receiver is in the plurality of zones.

27. The method of claim 24, further comprising synchronizing the transmitter or the receiver and the master node together to a reference base time of the master node.

28. The method of claim 20, further comprising: installing moveable rig equipment at the rig site when the location of the moveable rig equipment meets a pre-selected location.

29. A system for tracking a position on a rig site, comprising:
at least one moveable transmitter at a first location on the rig site configured to transmit a reference signal;
a plurality of static receivers of defined positions on the rig site configured to receive the reference signal from the moveable transmitter, determine the reception time of signal, and transmit reception information to a master node via a communication channel; and
wherein the master node is at a location on the rig site with reference base time, wherein the master mode receives the defined positions and reference times of the plurality of static receivers, and
wherein the system is configured to receive the reception information, determine signal travel times between the moveable transmitter and the static receivers, determine the distances or angles between the moveable transmitter and the static receivers based on a travel time of the reference signal, and determine a position of the first location.

30. The system of claim 29, wherein each of the plurality of static receivers comprises:
a receiving electronic having a receiving antenna that receives the reference signal;
a field-programmable gate array, or a digital application-specific integrated circuit, or a digital signal processor unit, or a processor configured to determine the arrival time either by correlate the received reference signal into the reception time information or by pulse recognition; and
a radio transmitter configured to transmit the reception time information to the master node.

31. The system of claim 29, wherein the moveable transmitter is disposed on rig equipment or a person.

32. The system of claim 29, further comprising:
a plurality of secondary static receivers disposed on a plurality of static rig equipment, wherein the master node is configured to map the rig site based on determined positions of the plurality of static rig equipment.

33. The system of claim 29, wherein the plurality of static receivers is selected and positioned to illuminate substantially all of the rig site either directly or by reflection.

34. The system of claim 33, wherein the plurality of static rig equipment includes a reflective surface, and wherein the master node accounts for a reflection of the reference signal when determining the position of the first location.

35. The system of claim 29, further comprising a network extending between the plurality of static receivers and the master node to synchronize the moveable beacon and the master node to the base reference time of the master node.

36. The system of claim 29, wherein the plurality of static receivers is installed at a plurality of locations on a rig floor and on a mast.

37. The system of claim 29, wherein the reference signal further compromises a wave that is coded over a sinusoidal signal or a short pulse.

38. The system of claim 37, wherein the wave is electromagnetic or acoustic.

39. The system of claim 38, wherein the electromagnetic wave is in the frequency range of 0.7 to 5 Gigahertz.
